(19) United States
(12) Patent Application Publication
(10) Pub. No.: US 2006/0265331 A1
(43) Pub. Date: Nov. 23, 2006

(54) System and method for marketing product

(76) Inventors: Allen Hughes, Springville, UT (US); Carrie Hughes, Springville, UT (US)

Correspondence Address: THORPE NORTH & WESTERN, LLP., 8180 SOUTH 700 EAST, SUITE 200, SANDY, UT, 84070, US

(21) Appl. No.: 11/412,712

(22) Filed: Apr. 26, 2006

Related U.S. Application Data
(60) Provisional application No. 60/675,324, filed on Apr. 26, 2005.

(51) Int. Cl. G06Q 99/00

(52) U.S. Cl. 705/52

(57) ABSTRACT

A network technique for distribution of proprietary products is disclosed. The technique includes a direct distribution marketing component whereby all participants in the network can participate as creators, distributors, or end users and share in revenue streams.

### CROSS-REFERENCE TO RELATED APPLICATIONS AND CLAIM OF PRIORITY

Priority to U.S. Provisional patent application Ser. No. 60/675,324 filed on Apr. 26, 2005 is claimed.

### BACKGROUND OF THE INVENTION

Current business methods used in the distribution industries for distributing creative works, proprietary works and other creative products tends to stifle the creation and promotion of artistically driven products such as music, literature, artwork and other creative mediums. For example, the music industry has created a bar for artists entering the multi-billion dollar music marketplace. Distributors tend to strip artists of control over their music and turn the artists into commodities to be manipulated. In a worse case scenario, the artists can end up as virtual slaves of the promotion engine. This example can also be broadly applied to other areas such as book publishing houses, software game publishers and similar business models that tend to stifle creativity due to the large amount of capital the distributors invest to distribute these products.

Such problems can be examined more deeply in the context of the music and publishing industries. However, these problems are not limited to these industries, but can be similarly applied to other industries as described above. Music listeners and book readers generally have little influence on the promotion of the music they want to hear or the books that are presented to them. Of course, consumers can refuse to purchase types of music and books that do not appeal to them. However, music listeners and book readers do not generally have a significant choice concerning the types of music or books that they are exposed to in a given genre by the distribution houses. Some small independent publishing labels have developed to distribute music or books that are driven more by the musical aspects or written content of the product instead of the marketing aspects of the product. Unfortunately, independent distributors do not have a strong marketing vehicle to promote their artists and authors.

In the example of the recording industry, the major record companies (aka “Majors”) will often search out and sign several “up and coming” artists to recording contracts that fit a specific profile. Then the recording studios will promote one artist heavily (not necessarily the most talented but the most marketable) while minimally promoting the others. The Majors have significant control of which artists make it in the world of music. This control ranges from the statistical analysis of the market, to killing off competition, and as a result the Majors end up controlling the creative direction of music.

In other words, music listeners are force fed what the Majors consider music. As a result, many maturing listeners cannot find music they connect with anymore. They are turning off the radio and are looking for alternative music sources for their listening and buying pleasure. Independent music is attracting a growing number of listeners throughout the world. Although, independent music is growing, independent musicians and/or their labels are isolated from each other. By their nature these labels have little cumulative power to affect a significant flow of resources or the creative direction of art in the music industry.

The Majors have instituted a business practice of signing many artists in a genre, but then promoting only one or two in order to control the market. Market control helps the Majors to maximize profits, minimize losses and lock up the progress of bands that are contracted to them. For example, the Majors pay the up front costs for producing and marketing an artist's album. In exchange, the artist is required to pay the cost of production and related costs back to the Distributor. Unless an artist sells millions of CD's, they are usually indebted to the “Majors” for the album or CD they just made. So even if the artist wanted to switch distributors, this would be difficult because of the debt owed to the first Major who signed them.

This type of system strips the artists of control over their artwork and music. Due to the contracts the artists enter, the artists often lose control of their identity and music to the Majors or larger Independent Distributors in exchange for promoting their music. As a result of these forces, the artists become commodities to Distributors and slaves of the promotion system. The lifestyle of the average artist is very difficult. Most artists are lucky to get any remuneration for performances. Those who have a following and have a recording contract make more money from concert sales than music product sales.

In both the recording and book industry, distributors often book artists and authors on heavy tour schedules in order to promote their product sales. In this situation, artist's and author's personal lives often suffer, they lose their family life, have difficulty excelling in other business ventures, and often end up spending their time promoting their old music and books instead of creating new music and books. While these problems are best illustrated in the context of the recording and book publishing industry, the problems described apply to many industries. What is needed is a better way of distributing creative work product and rewarding the creators of that artistic product.

### BRIEF DESCRIPTION OF THE DRAWINGS

FIG. 1 is block diagram illustrating a system for distributing proprietary content and/or products in accordance with an embodiment of the present invention;

FIG. 2 is block diagram illustrating a system for distributing proprietary content or products from a creator of the proprietary content in accordance with an embodiment of the present invention;

FIG. 3 is block diagram illustrating a system for distributing proprietary content using a stepped structure in accordance with an embodiment of the present invention;

FIG. 4 is block diagram illustrating a system for distributing proprietary content a grassroots filtering system in accordance with an embodiment of the present invention

FIG. 5 is flowchart illustrating a method for distributing proprietary content in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

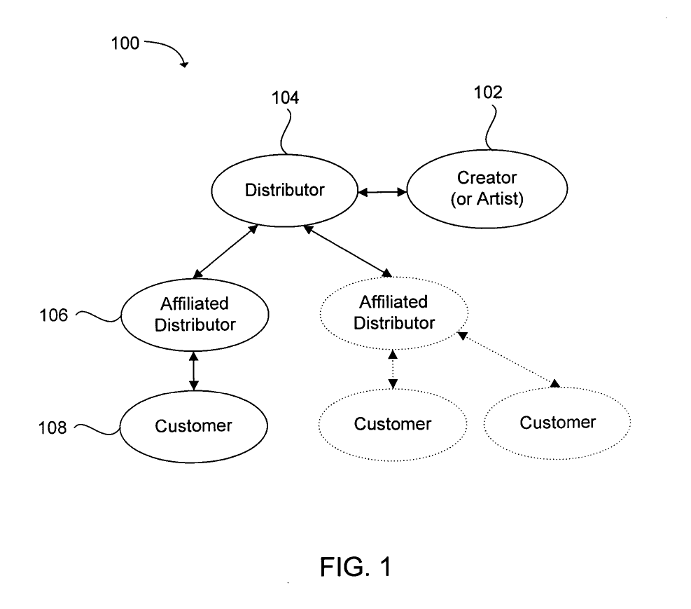

In accordance with an embodiment of the present invention, a system for distribution of proprietary or non-proprietary products is provided. In particular, the system can be effective for delivering digital products or digital creative works. FIG. 1 illustrates one embodiment of a direct distribution system for marketing proprietary works. The system includes a distributor 104 of a proprietary work. The distributor can also be part of a direct distribution structure 100 and receive a first distribution compensation for each proprietary work sold through the direct distribution structure. Proprietary works can generally be defined as a creative work, derivative work, improved product, or patented product where the ownership of the work is held exclusively by one or more creators or authors.

An affiliated distributor 106 of the proprietary work can also be included in the direct distribution structure 100. The affiliated distributor may receive a second distribution compensation for each proprietary work sold. While the distributions are defined as a first, second or third distribution, this is not intended to imply any actual time order to the payments. When the proprietary work is sold then a portion of the proceeds is paid to the affiliated distributor (e.g., second distribution) who sells the product and other portions of the proceeds may be paid to supervisory distributors (e.g., first distribution) who are upline in the direct distribution structure from the selling distributor. There are a number of configurations that the direct distribution structure can take. For example, the direct distribution structure can be a 3×7 matrix or binary marketing system.

A creator 102 (or creators) of the proprietary work for sale by the distributor 104 and affiliated distributor 106 in the direct distribution structure can also be included in the payment structure. The creator can receive an unshared royalty or licensing fee for each sale of the creator's own proprietary works through the direct distribution structure. This unshared royalty is paid to the creator or artist whether or not the creator is part of the direct distribution structure. However, the monetary proceeds paid to the creator can increase if the creator joins the direct distribution structure or network.

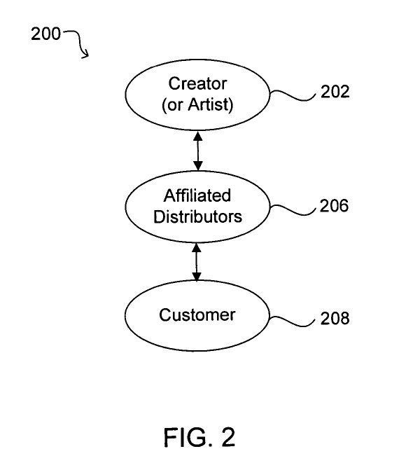

FIG. 2 further illustrates an embodiment of a direct distribution system for marketing proprietary works. For this embodiment, the creator 202 and the distributor can be the same single entity. In other words, this means that the creator of the proprietary product can also be the managing or supervisory distributor for the direct distribution structure. The creator can then receive the marketing compensation for their proprietary product that they sell or their downline sells. In addition to the marketing proceeds, the creator can also receive the undivided royalty proceeds. In this context, the undivided royalty of the proceeds means that the royalties are not divided with a large publishing and distribution house.

In an alternative embodiment of FIG. 2, the affiliated distributor 206 can be the creator of a proprietary work for sale within the direct distribution structure instead of the supervisory distributor. As a result, the affiliated distributor or creator can receive a payment for their marketing efforts and a separate payment or an unshared royalty for each sale of the creator's own proprietary work within the direct distribution structure. This allows artist to take part in the revenues that are generated from creating their work and from marketing the work. In addition, the creator can also receive revenues from promoting the proprietary works of other artists while they are promoting their own proprietary work.

The creator may also take the alternative position of the customer or user 208 at the lowest tier. In this position, the creator can purchase the products of other direct distribution structures while still receiving compensation for their own creative works. Thus, a creator who did not want to be involved in marketing efforts can still be rewarded for the efforts and purchase others proprietary works.

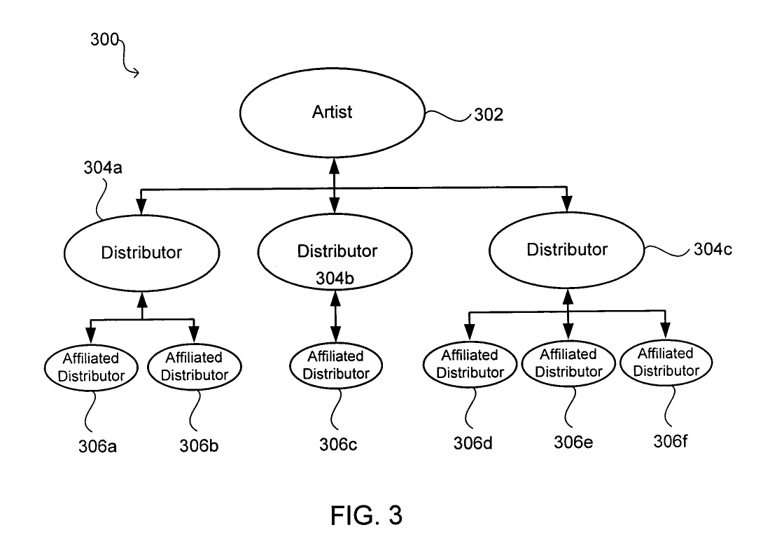

While FIGS. 1 and 2 illustrate a two-tiered system, the direct distribution structure can be multi-tiered with several levels of direct compensation and indirect compensation. The titles of the distributors and affiliated distributors in the direct distribution structure may vary along with the percentages and number of compensation levels that are available. For example, there may be an affiliated distributor that has a subsequent affiliated distributor receiving a third distribution compensation for each proprietary work sold by the subsequent affiliated distributor. This pattern may be repeated as many times as desired by the direct distribution structure and also result in breakaway groups or leadership bonuses. FIG. 3 illustrates an artist or creator 302 that is participating in a larger multi-tiered system with many distributors 304a-c and many affiliated distributors 306a-f or sub-distributors.

In certain embodiments of the invention, the proprietary work can be music, books, movies, visual arts, software, photography, electronic games, training materials, speeches, poetry, radio programs, and digital media products. Since the creator of the proprietary work desires to sell the work without contracting with a major distribution company, then the direct selling network of the present invention allows them to be their own distributor.

In a separate embodiment of the invention, the distributors and the affiliated distributors may also sell a non-proprietary good or service within the system. If the distributors and affiliated distributors are the suppliers of the product, then they may receive a commission for each of the non-proprietary works sold within the system, and a direct distribution structure compensation (or marketing payment) for each non-proprietary good or service they sell.

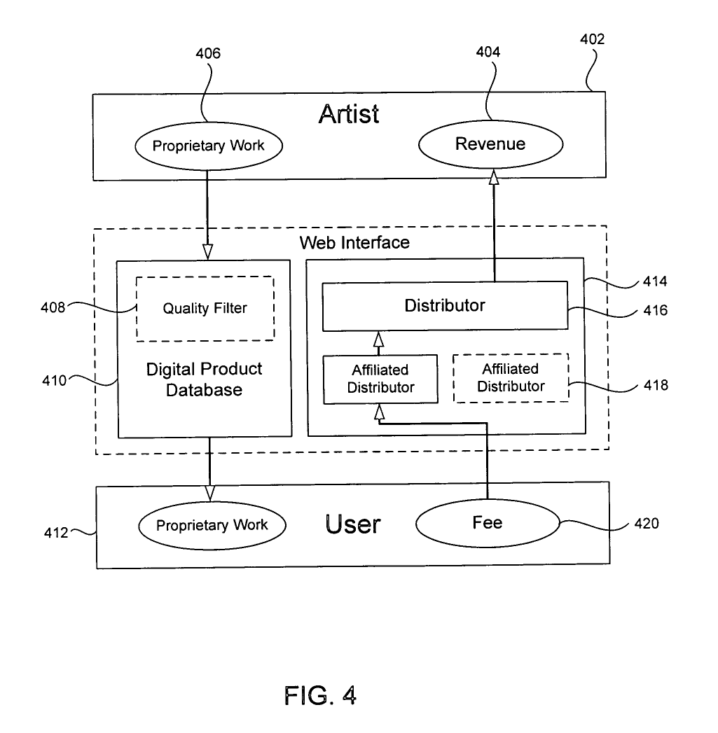

FIG. 4 illustrates a system where an Internet based website or client application can be used for distributing the proprietary products. The use of the Internet website allows distributors, creators and customers to interface through the Internet. For example, a creator can upload the proprietary product and then a customer can purchase the proprietary product through the website from a distributor or affiliated distributor through the website. FIG. 4 will be described in additional detail later using a specific product embodiment.

The Internet based website can be configured to enable other Internet based software that drives a direct selling system to plug into the web browser and business system. The website can further include tools for training distributors, affiliated distributors, creators, end customers, and other related to the direct distribution structure.

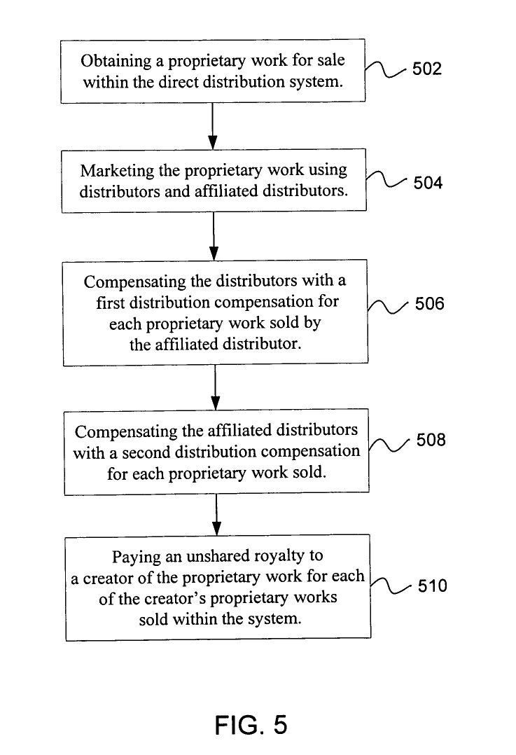

FIG. 5 illustrates a method for marketing a proprietary product within a direct distribution system. A first operation in the method can include obtaining a proprietary work for sale within the direct distribution system, as in block 502. The proprietary work may be uploaded to the web marketing platform by the creator. Alternatively, the proprietary work may be under license from a separate distributor of the work, such as in independent music or book publisher.

A further operation is marketing the proprietary work using distributors and affiliated distributors, as in block 504. After the product has been sold, the distributors can be compensated with a first distribution compensation for each proprietary work sold by the affiliated distributor, as in block 506.

A further operation is compensating the affiliated distributors with a second distribution compensation for each proprietary work sold, as in block 508. In addition to the compensation paid for the direct distribution structure, an unshared royalty can be paid to a creator of the proprietary work for each of the creator's own proprietary works sold within the system can take place, as in block 510.

As discussed previously, the product may be either a proprietary creative work or a non-proprietary good or service made by a distributor or affiliated distributor. In the case of a non-proprietary product, the distributor or affiliated distributor can receive a profit for each non-proprietary good or service sold in the system and a first distribution compensation for marketing the non-proprietary good or service.

A more profitable revenue position is when a new creator is accepted into the system and provides a proprietary work of art for sale by the new creator. The additional profit is due to the creator's involvement in the marketing of the proprietary work and the creation of the product. As the direct distribution structure grows, new affiliated distributors can be recruited into the system, by the distributor, to participate in selling, buying, and marketing of the proprietary work. Of course the new distributors can be compensated for each proprietary work they sell with compensation distributions.

One detailed example of the embodiment of the system enables electronic delivery of an artist's proprietary music combined with a grassroots (people-to-people) marketing structure.

Within the system, the artists, distributors, and listeners can share the rewards of producing and distributing music. While the present system and method can be effective for many types of creative and non-creative works, an example of the present system and method will be described within the context of digital music. However, any number of proprietary products can be used with the present invention such as books, artwork, software, video game software, digital images, and so on.

Under the present embodiment, artists can be compensated for their participation in product distribution. Artists may share in the profits of product distribution not only for their own music, but the music of other artists as well. Artists can be taught how to professionally engage their fan base (a listener or customer) into a natural and profitable distribution network.

The listener may also have the opportunity to participate in the profits of the grass-roots distribution network. This allows listeners to profit from a natural desire to promote artists and the music they love. Through the purchasing power of this grass-roots distribution model, the listener or purchaser has a major influence on the development of art-driven music. The system allows the power of independent musicians and grass-roots distribution networks to be harnessed into a force that allows artists to make enough money as a musician to further create and produce music the listeners want to hear and buy.

FIG. 4 further illustrates an embodiment of the system for the distribution of digital music. The system includes an artist interface 402 that may include a new song/artist submission center. The artist interface enables an artist to upload music 406 and related proprietary works into the system or allows the artist to manage songs in the system. Songs may include digital records, digital music videos, or other digitally embodied products. The artist interface may also include the ability for the artist to enter promotional material into the system, including for example descriptive material.

Optionally, songs may be screened for technical and quality standards using a quality filter 408 before being stored in a digital product database 410 and released for general distribution. The system may include processes for verifying the identity, ownership, distribution rights of artists, and executing legal agreements with artists, including for example indemnification and authorization for distribution. Additionally, new artists may be screened by a human panel before being allowed to distribute music into the system. Artists may be rated using a multi-tiered rating system, including, for example, a professional rating team, VIP judges, grass-roots distributors, online voting.

Promotion of digital records may occur in a variety of ways, including for example “top-20” popularity lists, critics recommendations, recommendations based on personal choices or previous purchase patterns of individual listeners. Marketing events may be held live using streaming video, web casting, satellite radio and pod casting to connect Distributors, Artists and Listeners into House Concerts, Concert Tours and National Conventions.

In addition to allowing the artists to provide music, the system can also allow artists to provide music videos, artwork to accompany the music, photographs, album inserts and the like, which are available for purchase and download. Feature length videos, short video works, animations and similar videos can also be uploaded and distributed using this system. Other creative works can also be distributed using the present system, such as digital books or dramatic works, instructional audio or video, brochures and similar mass media items.

The system also includes a distributor interface 414. Of course, artists, independent distributors (minor distributors called “Indy Labels”), and listeners can all be distributors. The distributor interface may include, for example, distributor tools, including tools to manage personal distribution sites. For example, individual distributors may be assigned to individual web pages by which they track the uplines/downlines and upline or affiliated distributors 418 with which they are participating. The distributor interface may include online business training and support tools, contact management, and similar tools.

The present system is different than prior direct marketing distribution systems because the product is generated and introduced by the individuals and artists involved as the distributors. In a typical distribution system, the product usually originates from the marketing company itself or from some other manufacturing source. In other words, the creators of the product (i.e. the artists) are involved in the direct marketing and distribution.

The system also includes a user or listener interface 412, which may include a music download center for purchasing songs, a music shopping cart, and a song library (or music database). The listener interface may provide access to databases of artists, web pages for individual artists and distributors, samples of music from the artists which may include the “hook” (the unique phrase of the musical passage), and review information on individual artists and individual songs.

Of course, artists and distributors can also be listeners, and vice versa. Payment 420 for downloaded music may be accomplished using song vouchers, song credits tracked within the system, or credit card payments. Song vouchers may also be provided by a distributor for a specific song only and the song voucher can be sent to prospective distributors or as gifts. The system may also interact with banking and merchant accounts directly. The system may include click-wrap or browse-wrap licensing agreements, for example prohibiting the further distribution of digital recordings outside the system or sending of bulk email using the system.

The system may include a public site by which new artists, distributors, and listeners may enter into the system. For example, new artists, distributors, and listeners may be directed to a web-based customer and distributor sign up and training center which creates new accounts within the system.

As discussed, the system may include a multilevel marketing component within the system by which artists, distributors, and listeners are compensated for their grassroots marketing efforts. This multilevel structure can be viewed through the distributor interface 414 along with revenue 404 provided for artists 402 or distributors in an upline or downline. Prior to this time, independent artists have not distributed their digital productions and/or products in a system that uses a multilevel marketing component. The multilevel marketing component can interact with the song credit tracking and credit card processing components to keep track of revenue share in the form of cash or song credits.

Distributors may be provided with song vouchers or song credits which may be forwarded to new participants to encourage them to join the network. In addition, distributors may purchase song vouchers or song credits to forward to potential networking associates and allow them to try the system. Because the distributors can purchase credits and the music downloads may occur through a company download site, this means that the distributors do not need to carry inventory as in other types of direct marketing systems. When a recipient of a music credit uses the music credit, then the recipient of the credit may join the distributor's business network or down-line. Alternatively, a recipient of the credit may opt to join under another distributor's down-line at a later point in time. Users may also enter the network by accessing an artist's or distributor's home page, and the user can purchase music downloads which will put the listener or user into the artist's or distributor's down-line.

The use of music credits will also be tracked by the system. This allows a distributor to view exactly when, where, and who is using the credits. A distributor may then follow-up with individuals who have received a credit from the distributor depending on the use of the credit.

Implementation of components of the system may be provided by a variety of technologies known in the art. For example, components may be implemented using web servers providing web pages using Hyper Text Transfer Protocol (HTTP), Microsoft Active Server Pages (.ASP), Microsoft ActiveX controls, Macromedia Flash, or Java. Some components may be implemented using available multi-level software components or modified versions of standard software.

In accordance with another embodiment of the present invention, a method for compensating participants in a digital music distribution network is now described. The method includes enabling any participant to be a distributor in the network. The method thus leverages pre-existing and new grass-roots networks where participants sell music to their friends and artists sell music to their fans. The method may also include sharing revenues between distributors and artists. The method may also include distributing shared revenues on a periodic basis.

A further example of how the method can operate will now be illustrated with a narrative. Listener Allen is a big fan of the artist Shane. While viewing a fan site about Shane, Allen reads a posting by Thom saying he has picked up Shane's latest music “My Umbrella” from the system with an excellent review. Allen may then go to the system website and purchase and download the music. While downloading the song, Allen may learn that a portion of the revenue from every song goes to the artist and that another portion of the revenue is shared by whoever helps to market the music through the present invention.

Allen may then sign up to be a grass-roots distributor and call or email his friends to tell them about the new song. Weeks later, Allen gets a check or a credit for his share of the revenues as defined by the direct distribution structure. This motivates Allen to work even harder to help build Shane the biggest fan base ever. The method can thus build a reinforcing cycle, where listeners are financially motivated to become distributors of an artist's music, and distributors are motivated to market and promote an artist's music. Artists can then obtain a greater share of revenue and are motivated to produce more music. In short, everyone benefits in a system where personal music discoveries and choices can be shared with everyone else.

In another embodiment, the use of Digital Rights Management (DRM) technology may be avoided through the unique features of the method and system. Listeners do not like DRM since it makes it difficult to transfer songs they have purchased between the different formats and systems they use (for example, a listener may wish to have a CD for their car or home stereo system and also have the tune in their iPod). By avoiding the use of DRM, listeners obtain a more useful music product that can be easily downloaded and transferred to different players. Because it is easy for listeners to become distributors and distributors share in the revenue, then incentives for free sharing of music are reduced. Distributors are thus encouraged by their own self interest (i.e., a Social DRM) to not give away music they have downloaded for free, but instead to encourage the members of their personal grassroots networks to join as participants. However, if a distributor, artist, or listener circumvents the agreements with the distribution network and is involved in piracy of the product, then the company may take action to remove the offender from the business or cut them off as a distributor.

The system may be enhanced by a variety of features, including email interest lists, online rating and voting, bulk email filtering, electronic authentication of participants, electronic distribution of song vouchers and song credits and funds, electronic watermarking to help identify and track piracy and/or compliance with network agreements, popularity based revenue sharing based on grassroots feedback.

The system and method leverages grass-roots distribution networks that already exist in the music industry. Artists are often avid listeners, and many successful artists are proficient distributors. In addition, listeners are often some of the biggest promoters of new music.

Without having to relinquish their business identity or goals, a grassroots distribution network empowers individuals and independent labels (minor distributors) with a vested, evangelistic marketing force and customer base to drive the creation of art-driven music. Through these means, individuals and small independent labels can gain market power which allows them to better promote themselves or their artists and obtain a greater share of the industry revenues. In other words, each individual's purchase drives the overall popularity of particular music and decentralizes the music industry.

While the detailed example described above uses the music industry as an example for using the present invention, the direct distribution structure described herein can be used for other areas where proprietary works are generated. Examples of such areas include but are not limited to books, software, electronic artwork, tangible artwork, video works, movies, television programs and similar products. The present invention is not limited to proprietary works where the ownership of the work is held by one or more creators or authors. Non-proprietary works can also be sold through the present system even though an unshared royalty may not necessarily be paid to a creator. For example, personal care products, cooking products, art supplies, scrapbooking supplies, make-up, and other items may be sold along with the proprietary works.

Ultimately, a grassroots distribution network can: 1) provide artists more control over their music and their lives; 2) provide artists more time to create more music; 3) invite more unknown artists into the world of music; 4) provide listeners with true listening choices; 5) provide listeners the opportunity to promote artists; and 6) pay listeners for the natural role they play in the distribution process. In summary, the present invention provides a creator-centered grassroots distribution community that is open to individuals, groups, companies and others who desire to participate in distributed product marketing efforts.

It is to be understood that the above-referenced arrangements are only illustrative of the application for the principles of the present invention. Numerous modifications and alternative arrangements can be devised without departing from the spirit and scope of the present invention, including for example omission of elements described above or addition of other elements as will occur to one of skill in the art. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A direct distribution system for marketing proprietary works, comprising:
a distributor of a proprietary work having a direct distribution structure and receiving a first distribution compensation for each proprietary work sold through the direct distribution structure;
an affiliated distributor of the proprietary work in the direct distribution structure, and the affiliated distributor receiving a second distribution compensation for each proprietary work sold; and
a creator of the proprietary work for sale by the distributor and affiliated distributor in the direct distribution structure, wherein the creator receives an unshared royalty for each sale of the creator's own proprietary works through the direct distribution structure.

2. The system of claim 1, wherein the creator and the distributor are one entity.

3. The system of claim 1, wherein the affiliated distributor is a creator of a proprietary work for sale within the direct distribution structure, and the affiliated distributor receives an unshared royalty for each sale of the creator's own proprietary work within the direct distribution structure.

4. The system of claim 1, further comprising a subsequent affiliated distributor receiving an additional distribution compensation for each proprietary work sold by the subsequent affiliated distributor, and the distributor receiving a distribution compensation for each proprietary work sold by the subsequent affiliated distributor.

5. The system of claim 1, wherein the distributor and the affiliated distributor further sell a non-proprietary good or service within the system, and receive commission for each of the non-proprietary work sold within the system, and a second distribution compensation for each non-proprietary good or service they sell.

6. The system of claim 1, wherein the proprietary work can be selected from a group consisting of: music, books, movies, visual arts, software, photography, electronic games, training materials, speeches, poetry, radio programs, and digital media products.

7. The system of claim 1, wherein the direct distribution system can be a 3×7 matrix or binary marketing system.

8. The system of claim 1, further comprising an Internet based website for marketing the proprietary digital works using a direct distribution structure.

9. The system of claim 8, wherein the Internet based website can be configured to allow other Internet based software to plug into the Internet based web site.

10. The system of claim 8, wherein the affiliated distributor can market the proprietary work from the website, from which a user can purchase the proprietary work.

11. The system of claim 8, wherein the Internet based website further comprises tools for training distributors and affiliated distributors.

12. A direct distribution system for marketing proprietary works, comprising:
a creator of a proprietary work for sale within the direct distribution system and the creator is the distributor of the proprietary work;
an affiliated distributor linked to the creator, and the creator receives a first distribution compensation for each proprietary work sold by the affiliated distributor and an unshared royalty for each sale of the work of art within the direct distribution system; and
wherein the affiliated distributor of the proprietary work receives a second distribution compensation for each proprietary work sold.

13. The system of claim 12, wherein the affiliated distributor can also be a creator of a proprietary work for sale within the system, receiving an unshared royalty for each sale of their own proprietary work within the system.

14. The system of claim 12, wherein the creator and the affiliated distributor can offer for sale a non-proprietary good or service within the system, and receive an commission for each of the non-proprietary work sold within the system, and a second distribution compensation for each non-proprietary good or service they sell.

15. A method for marketing a proprietary product within a direct distribution system, comprising:
obtaining a proprietary work for sale within the direct distribution system;
marketing the proprietary work using distributors and affiliated distributors;
compensating the distributors with a first distribution compensation for each proprietary work sold by the affiliated distributor;
compensating the affiliated distributors with a second distribution compensation for each proprietary work sold; and
paying an unshared royalty to a creator of the proprietary work for each of the creator's own proprietary works sold within the system.

16. The method of claim 15, further comprising marketing a non-proprietary good or service by a distributor or affiliated distributor, wherein the distributor or affiliated distributor receive a commission for each non-proprietary good or service sold in the system and a first distribution compensation for each non-proprietary good or service they sell.

17. The method of claim 15, further comprising accepting a new creator into the system and providing for sale a proprietary work of art by the new creator.

18. The method of claim 15, further comprising recruiting a new affiliated distributor into the system, by the distributor, to participate in selling, buying, and marketing of the proprietary work, the new distributor being compensated for each proprietary work they sell with a second distribution compensation.

19. A direct distribution system for marketing proprietary works, comprising:
a downline structure including a distributor of a music work that receives a first distribution compensation for each music work sold by the downline structure;
an affiliated distributor of the music work in the downline structure, and the affiliated distributor receiving a second distribution compensation for each music work sold; and

20. The system as in claim 19, further comprising a creator of the music work for sale by the downline structure, wherein the creator receives an unshared royalty for each sale of the creator's own proprietary works.

21. The system of claim 20, wherein the creator and the distributor are one entity.

22. The system of claim 1, wherein the affiliated distributor is a creator of a proprietary work for sale within the downline structure, and the affiliated distributor receives an unshared royalty for each sale of the creator's own proprietary work within the downline structure.

23. The system of claim 1, further comprising the affiliated distributor having a subsequent affiliated distributor receiving a third distribution compensation for each proprietary work sold by the subsequent affiliated distributor, and the distributor receiving a distribution compensation for each proprietary work sold by the subsequent affiliated distributor.
